(19) United States
(12) Patent Application Publication
(10) Pub. No.: US 2026/0217268 A1
(43) Pub. Date: Jul. 30, 2026

(54) OPERATION SUPPORT DEVICE, RUNNING MANAGEMENT SYSTEM, AND OPERATION SUPPORT METHOD

(71) Applicant: HITACHI, LTD., Tokyo (JP)

(72) Inventors: Shinji ISHIHARA, Tokyo (JP); Ryu NARIKAWA, Tokyo (JP); Kazuya SUGIMOTO, Tokyo (JP); Hiroki OBARA, Tokyo (JP)

(21) Appl. No.: 19/455,939

(22) Filed: Jan. 22, 2026

(30) Foreign Application Priority Data
Jan. 24, 2025 (JP) 2025-010962

(51) Int. Cl. B60W 50/08; B60W 50/00

(52) U.S. Cl. CPC B60W 50/085; B60W 2050/0016

(57) ABSTRACT

An operation support device includes a control command value calculation unit configured to calculate a control command value for a control target based on a target value of a state quantity to be operated on the control target. The operation support device includes a determination unit configured to determine whether the control command value deviates from a running condition of the control target. The operation support device includes a correction unit configured to calculate a corrected target value obtained by correcting the target value to satisfy the running condition when the determination unit determines that the control command value deviates from the running condition. The operation support device includes a display control unit configured to output a running management screen including the target value and the corrected target value.

### CROSS-REFERENCE TO RELATED APPLICATION

The present application claims priority from Japanese application JP2025-010962, filed on Jan. 24, 2025, the content of which is hereby incorporated by reference into this application.

### BACKGROUND OF THE INVENTION

### 1. Field of the Invention

The present invention relates to an operation support device, a running management system, and an operation support method for supporting an operation of a control target.

### 2. Description of Related Art

When an operator operates or runs a system, a recommended operation may be provided to the operator as guidance. However, when a person gets used to follow the guidance, there is a possibility that the person loses an opportunity to acquire the ability to make a determination.

A technique disclosed in Patent Literature 1 is a technique for reviewing an operation performed by an operator. Patent Literature 1 discloses that “an advice generation unit generates advice related to a running operation using a transition of a relationship between actual operation information acquired by an actual operation information acquisition unit and ideal operation information calculated by an ideal operation information calculation unit, and specifically, when a period in which a deviation between the actual operation information and the ideal operation information is relatively large continues for a long time, the advice generation unit generates advice related to a running operation that reduces the deviation”.

### CITATION LIST

### Patent Literature

PTL 1: JP2017-220171A

### SUMMARY OF THE INVENTION

In a safe driving support device disclosed in Patent Literature 1, since an actual operation of an operator is compared with an ideal operation, it is difficult to use the safe driving support device when the ideal operation cannot be defined. For example, in a situation where it is difficult to specify an intention of a driver, the safe driving support device may present an erroneous ideal operation. Even when the safe driving assistance device is applied to a control target such as a plant, it is difficult to apply the safe driving assistance device when an ideal state or operation of the control target is unknown in a new plant.

In order to improve a skill level by acquiring an ability for enabling the operator to make a determination, it is desirable to enable an operation reflecting an intention of the operator in a safe range that does not lead to an accident or a dangerous state, instead of presenting guidance from the beginning. In a situation where safety is guaranteed, the operator can acquire the ability for making a determination by performing trial and error for an operation based on own determination, and can be expected to improve the skill level. The present invention is also applicable to a control target whose ideal state or operation is unknown.

The present invention has been made in view of the above circumstance, and an object of the present invention is to provide an operation support device, a running management system, and an operation support method for enabling an operation that ensures safe running.

In order to solve the above problems, an operation support device according to the present invention includes: a control command value calculation unit configured to calculate a control command value for a control target based on a target value of a state quantity to be operated on the control target; a determination unit configured to determine whether the control command value deviates from a running condition of the control target; a correction unit configured to calculate a corrected target value obtained by correcting the target value to satisfy the running condition when the determination unit determines that the control command value deviates from the running condition; and a display control unit configured to output a running management screen including the target value and the corrected target value.

An operation support device includes: a control command value calculation unit configured to calculate a control command value for a control target based on a target value of a state quantity to be operated on the control target; a state quantity calculation unit configured to calculate a state quantity of the control target based on the control command value; a determination unit configured to determine whether the control command value deviates from a running condition of the control target; and a correction unit configured to calculate a corrected target value obtained by correcting the target value to satisfy the running condition when the determination unit determines that the control command value deviates from the running condition, in which the control command value calculation unit calculates the control command value as a first corrected control command value based on the corrected target value, the state quantity calculation unit calculates the state quantity of the control target based on the first corrected control command value, the determination unit determines whether the state quantity of the control target deviates from the running condition, and the correction unit calculates a second corrected control command value obtained by correcting the first corrected control command value to satisfy the running condition when the determination unit determines that the state quantity of the control target deviates from the running condition.

According to the present invention, it is possible to provide an operation support device, a running management system, and an operation support method for enabling an operation that ensures safe running. Problems, configurations, and effects other than those described above will be clarified by the following description of embodiments.

### BRIEF DESCRIPTION OF THE DRAWINGS

FIG. 1 is an overall configuration diagram showing a running management system according to a first embodiment.

FIG. 2 is a diagram showing dynamic features of a control system including an operation support device and a control target according to the first embodiment.

FIG. 3 is a diagram showing dynamic features of the control system including the operation support device and the control target using formulas according to the first embodiment.

FIG. 4 is a diagram showing processing in which a correction unit corrects a target value according to the first embodiment.

FIG. 5 is a diagram showing processing in which the correction unit corrects a control command value according to the first embodiment.

FIG. 6 is a screen configuration diagram showing a running management screen according to the first embodiment.

FIG. 7 is a screen configuration diagram showing a running management screen according to the first embodiment.

FIG. 8 is a screen configuration diagram showing a running management screen according to the first embodiment.

FIG. 9 is a flowchart showing operation support processing according to the first embodiment.

FIG. 10 is a flowchart showing the operation support processing according to the first embodiment.

FIG. 11 is a diagram showing a deviation of a state quantity when a control cycle is long according to the first embodiment.

FIG. 12 is a diagram showing prevention of deviation of a state quantity when a control command value is corrected in a short cycle according to the first embodiment.

FIG. 13 is a functional block diagram showing an operation support device according to a second embodiment.

FIG. 14 is a functional block diagram showing an operation support device according to a third embodiment.

FIG. 15 is a screen configuration diagram showing a running management screen according to the third embodiment.

FIG. 16 is a functional block diagram showing an operation support device according to a fourth embodiment.

FIG. 17 is a screen configuration diagram showing a running management screen according to the fourth embodiment.

FIG. 18 is a functional block diagram showing an operation support device according to a fifth embodiment.

FIG. 19 is a hardware structure diagram showing an example of a computer that implements functions of the operation support devices according to the above embodiments.

### DESCRIPTION OF EMBODIMENTS

Overview of Operation Support Device An overview of an operation support device according to an embodiment of the present invention will be described below. When a target value of an operation of a control target instructed by an operator satisfies a running condition up to a predetermined period, the operation support device calculates a control command value corresponding to the target value of the operation and outputs the control command value to the control target. When the target value of the operation instructed by the operator does not satisfy the running condition, the operation support device corrects the target value to satisfy the running condition.

The target value is a target value of a state quantity of the control target. The target value includes, for example, a running temperature and running pressure in a chemical plant. The control command value is a parameter of a control command to an actuator provided in the control target. The control command value includes, for example, an opening level of a valve and an output of a pump. The running condition is a condition under which the control target can operate safely. The running condition includes, for example, a condition (an upper limit, a lower limit, and a running range) for the control command value, a condition for the state quantity, and the like.

According to such an operation support device, even if an operator instructs (inputs or sets) an erroneous target value, safety of the control target can be ensured. As long as the control target is safe, the operation support device controls (runs) the control target according to the target value instructed by the operator. Therefore, the operator can know a state of the control target depending on the target value. As a result, the operator can be expected to acquire an ability to make a determination for an operation of the control target and improve a skill level. In addition, when the operation support device outputs (displays) an instructed target value and a corrected target value, the operator can understand in what state the control target should be operated and how the control target should be operated. Hereinafter, the target value that is corrected is referred to as a corrected target value.

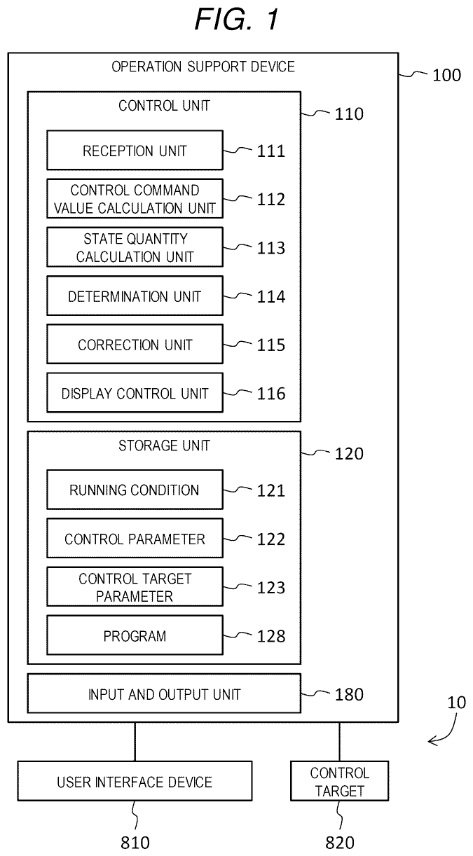

Configuration of Operation Support Device FIG. 1 is an overall configuration diagram showing a running management system 10 according to a first embodiment.

The running management system 10 includes an operation support device 100 and a control target 820. The control target 820 is a target operated or controlled by the operation support device 100, and is, for example, equipment or a machine installed in a chemical plant or a power plant.

The operation support device 100 is a computer and includes a control unit 110, a storage unit 120, and an input and output unit 180. A user interface device 810 such as a display, a keyboard, and a mouse is connected to the input and output unit 180. The input and output unit 180 includes a communication device and can transmit and receive data to and from the control target 820. A media drive may be connected to the input and output unit 180 to exchange data using a recording medium.

Operation Support Device: Storage Unit The storage unit 120 includes a storage device such as a read only memory (ROM), a random access memory (RAM), and a solid state drive (SSD). The storage unit 120 stores a running condition 121, a control parameter 122, a control target parameter 123, and a program 128. The program 128 includes description of processing of functional units provided in the control unit 110, which will be described later. Various storage contents of the storage unit 120 may be contents stored in an external storage device such as a cloud server and read as necessary.

The running condition 121 is a condition under which the control target 820 can be run safely. The running condition 121 includes, for example, a condition (upper limit and lower limit) for a control command value and a condition for a state quantity.

The control parameter 122 is a parameter that the operation support device 100 refers to for control of the control target 820. The control parameter 122 includes, for example, a parameter referred to when a control command value is calculated based on a target value.

The control target parameter 123 is a parameter indicating dynamic features of the control target 820.

### Operation Support Device: Control Processing

Before describing the control unit 110, control processing of the operation support device 100 for the control target 820 will be described. Hereinafter, it is assumed that the dynamic features (dynamics) of the control target 820 are expressed by a formula (1) for a state quantity x and a control command value u.

$$\dot{x} = f ( x , u ) \qquad ( 1 )$$

Here, the left side is a time derivative of the state quantity x. In other words, the formula (1) indicates how the state quantity x of the control target 820 changes by giving the control command value u. The formula (1) expresses the dynamics by a continuous time system, but may also be expressed by a discrete time system (difference equation) such as a formula (2).

$${x}_{k + 1} = f ( {x}_{k} , {u}_{k} ) \qquad ( 2 )$$

In the formula (2), subscripts k and k+1 indicate time. The dynamics may not be expressed as a formula such as a motion equation or a thermodynamic equation, and may be a machine learning model that calculates a state quantity xₖ₊₁ at a subsequent time according to a state quantity xₖ at a current time and a control command value uₖ. The formula (2) can also express such a machine learning model.

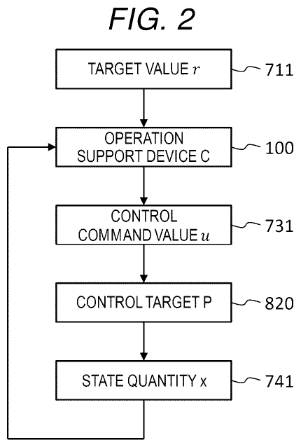

FIG. 2 is a diagram showing dynamic features of a control system including the operation support device 100 and the control target 820 according to the first embodiment. C represents a transfer function of the operation support device 100, and P represents a transfer function of the control target 820. In FIG. 2, a continuous time system (see the formula (1)) is assumed for simplicity of description.

The transfer function C can be determined from a control algorithm of a control command value calculation unit 112 to be described later. For example, when the control algorithm is proportional integral control (PI control), the transfer function can be given by a formula (3).

$$C ( s ) = \frac{{K}_{P} s + {K}_{I}}{s} \qquad ( 3 )$$

Here, K_{P} is a proportional gain, and K_{I} is an integral gain. Further, s is an operator of Laplace transform. On the other hand, the transfer function P is obtained by performing Laplace transform on the formula (1). Here, for simplicity, it is assumed that the transfer function P of the control target 820 is given by a formula (4).

$$P ( s ) = \frac{{ω}^{2}}{{s}^{2} + 2 ζ ω s + {ω}^{2}} \qquad ( 4 )$$

Here, ω is a natural angular frequency, ζ is a damping coefficient, and both are parameters indicating dynamic features of the control target 820 (see the control target parameter 123). Then, the control command value u (see a reference numeral 731) and an output of the control target 820 (a state quantity x (see a reference numeral 741)) can be calculated from a target value r (see a reference numeral 711) using formulas (5) and (6). The target value r is a target value of the state quantity x of the control target 820 input or set by an operator who is a user of the operation support device 100.

$$u = \frac{( {K}_{P} s + {K}_{I} ) ( {s}^{2} + 2 ζ ω s + {ω}^{2} )}{s ( {s}^{2} + 2 ζ ω s + {ω}^{2} ) + {ω}^{2} ( {K}_{P} s + {K}_{I} )} r \qquad ( 5 )$$

$$x = \frac{( {K}_{P} s + {K}_{I} ) {ω}^{2}}{s ( {s}^{2} + 2 ζ ω s + {ω}^{2} ) + {ω}^{2} ( {K}_{P} s + {K}_{I} )} r \qquad ( 6 )$$

By using these formulas, it is possible to calculate how the control command value u and the output (the state quantity x) of the control target 820 change with respect to any one of the target value r and control gains K_{P} and K_{I}. When an upper limit uₘₐₓ or a lower limit uₘᵢₙ of the control command value is given in the running condition 121, it is possible to predict whether the control command value u calculated using the formula (5) conflicts with the upper limit uₘₐₓ or the lower limit uₘᵢₙ. Similarly, when an upper limit xₘₐₓ or a lower limit xₘᵢₙ of the output (the state quantity x) is given, the formula (6) may be used.

Even when the same target value r is given, if the control gains K_{P} and K_{I} are changed, a change speed, a maximum value, and a constant value of a control command change, and thus a value of the control command may deviate from a running range (the running condition 121). In this manner, a parameter capable of changing a dynamic feature of a control loop is referred to as a parameter (the control parameter 122) related to the dynamic feature in the present invention.

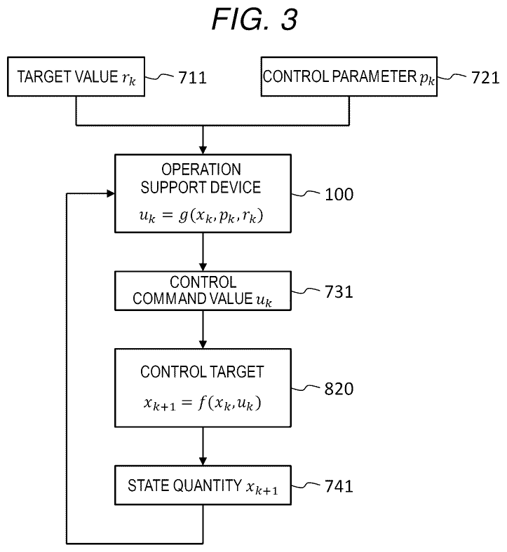

The same processing can be used when handling a more complicated control target or control algorithm. A formula (7) is considered as a general expression of a complicated control algorithm including a nonlinear element. FIG. 3 is a diagram showing dynamic features of the control system including the operation support device 100 and the control target 820 using the formula (7) according to the first embodiment.

$${u}_{k} = g ( {x}_{k} , {p}_{k} , {r}_{k} ) \qquad ( 7 )$$

In the formula (7), pₖ is the control parameter 122 at a time k input or set by an operator. The control parameter pₖ is, for example, a vector in which a proportional gain K_{P} and an integral gain K_{I} in proportional integral control are collected. The control parameter pₖ and a target value rₖ are determined by an input or setting of an operator.

By performing recursive calculation using the formulas (2) and (7), a control command value uₖ (see a reference numeral 731) and a state quantity xₖ₊₁ (see a reference numeral 741) at any time k can be calculated. Therefore, it is possible to easily determine whether these parameters deviate from a running range (see the running condition 121). The state quantity xₖ₊₁ is referred to when the control command value uₖ₊₁ is calculated at a time k+1 (see the formula (7). In order to simplify the description, discrete-time dynamics of the formula (2) is used unless otherwise specified.

As described above, in order to determine the deviation from the running condition 121 using the state quantity x, the dynamic features (dynamics) of the control target 820 need to include the state quantity x related to the running condition 121. For example, when the running condition 121 related to temperature is set, the state quantity x needs to include temperature.

Operation Support Device: Control Unit Returning to FIG. 1, the configuration of the control unit 110 will be described. The control unit 110 is implemented by a central processing unit (CPU), and includes a reception unit 111, the control command value calculation unit 112, a state quantity calculation unit 113, a determination unit 114, a correction unit 115, and a display control unit 116. For example, the control unit 110 may be a field programmable gate array (FPGA) or an application specific integrated circuit (ASIC).

Control Unit: Reception Unit The reception unit 111 receives the target value rₖ (see the reference numeral 711 in FIG. 2) and pₖ (see a reference numeral 721 in FIG. 3) serving as the control parameter 122, which are input or set by an operator who is a user of the operation support device 100.

### Control Unit: Control Command Value Calculation Unit

The control command value calculation unit 112 calculates the control command value uₖ based on the state quantity xₖ, the target value rₖ, and the control parameter pₖ (see the formula (7)) and outputs the control command value uₖ to the control target 820. Therefore, the operation support device 100 may be read as the control command value calculation unit 112 in FIG. 3. The state quantity xₖ is an actually measured value of a state quantity of the control target 820 at a time k or a predicted value of the state quantity calculated by the state quantity calculation unit 113 to be described later.

### Control Unit: State Quantity Calculation Unit

The state quantity calculation unit 113 calculates (predicts) the state quantity xₖ₊₁ at a subsequent time k+1 based on the state quantity xₖ and the control command value uₖ (see the formula (2)). The state quantity calculation unit 113 calculates the state quantity xₖ₊₁ as a predicted value at the time k+1 based on, for example, the state quantity xₖ actually measured at a current time k and the control command value uₖ. In FIG. 3, the control target 820 may be read as the state quantity calculation unit 113.

### Control Unit: Determination Unit

The determination unit 114 determines whether the control command value u or the state quantity x calculated from the target value r deviates from the running condition 121 using the formula (5) or the formula (6). The determination unit 114 may determine whether the control command value uₖ or the state quantity xₖ₊₁ calculated from the target value rₖ deviates from the running condition 121 using the formula (2) or the formula (7). The determination unit 114 may determine whether the deviation occurs in a period up to a predetermined time (from a time k to a time k+N).

As described above, the operation support device 100 includes the control command value calculation unit 112 that calculates the control command value uₖ for the control target 820 based on the target value rₖ of the state quantity xₖ to be operated on the control target 820.

The operation support device 100 includes the state quantity calculation unit 113 that calculates the state quantity xₖ₊₁ of the control target 820 based on the control command value uₖ.

### Control Unit: Correction Unit (Correction of Target Value)

The correction unit 115 corrects the target value r when the control command value u or the state quantity x deviates from the running condition 121. The correction unit 115 does not correct the target value r when the control command value u or the state quantity x does not deviate from the running condition 121.

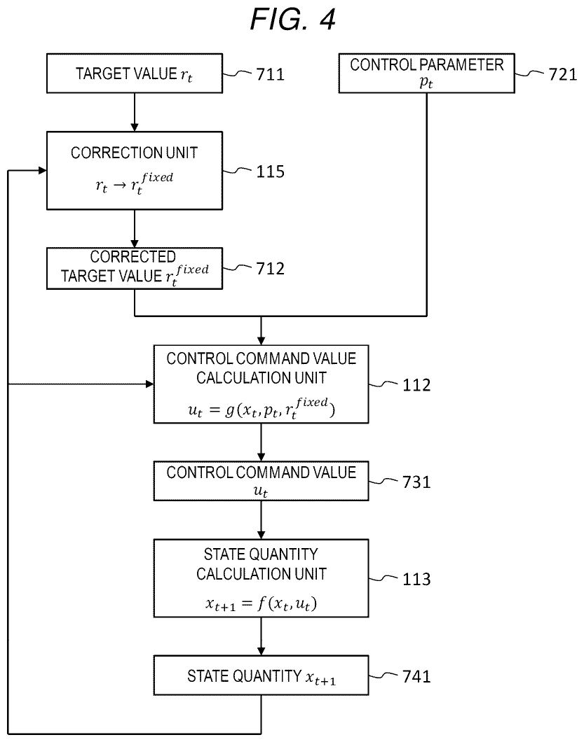

FIG. 4 is a diagram showing processing in which the correction unit 115 corrects a target value rₜ according to the first embodiment. When a control command value uₜ or a state quantity xₜ₊₁ calculated from the target value rₜ deviates from the running condition 121, the correction unit 115 corrects the target value rₜ to obtain a corrected target value rₜ^{fixed}. Here, it is assumed that the target value rₜ is known (t=k, . . . k+N) up to a time N. The correction unit 115 calculates corrected target values rₖ^{fixed}, . . . , r_{k+N}^{fixed} so that control command values uₖ, . . . u_{k+N} and state quantities xₖ₊₁, . . . x_{k+N+1} do not deviate in a period up to the time N. The correction unit 115 calculates the corrected target value rₜ^{fixed} (t=k, . . . k+N) using the following formulas (8) to (13).

$${r}^{fixed} = {arg min}_{{r}^{fixed}} {J}_{1} ( {r}^{fixed} ) \qquad ( 8 )$$

$${J}_{1} ( {r}^{fixed} ) = {\sum }_{t = k}^{k + N} {( {r}_{t}^{fixed} - {r}_{t} )}^{T} ( {r}_{t}^{fixed} - {r}_{t} ) \qquad ( 9 )$$

$${u}_{t} = g ( {x}_{t} , {p}_{t} , {r}_{t}^{fixed} ) \qquad ( 10 )$$

$${x}_{t + 1} = f ( {x}_{t} , {u}_{t} ) \qquad ( 11 )$$

$${u}_{m i n} \leq {u}_{t} \leq {u}_{m ax} \qquad ( 12 )$$

$${x}_{m i n} \leq {x}_{t} \leq {x}_{m ax} \qquad ( 13 )$$

The correction unit 115 calculates the corrected target value rₜ^{fixed} by solving an optimization problem with constraint conditions shown in the formulas (8) to (13). The formula (8) calculates the corrected target value rₜ^{fixed} by minimizing an objective function J₁(r^{fixed}) in the formula (9) using the formulas (10) to (13) as constraint conditions. The formula (9) is an objective function for evaluating the sum of deviations between the original target value rₜ and the corrected target value rₜ^{fixed}. In other words, the correction unit 115 calculates the corrected target value rₜ^{fixed} in which a change amount from the original target value rₜ is as small as possible and that satisfies the running condition 121 related to the control command value u and the state quantity x.

The formula (10) corresponds to the control algorithm (see the formula (7)), and the formula (11) corresponds to the dynamic features (see the formula (2)) of the control target 820. The formula (12) is the running condition 121 related to the control command value u, and the formula (13) is the running condition 121 related to the state quantity x. By solving the optimization problem in which the formulas (12) and (13) are incorporated as constraint conditions, it is possible to calculate the corrected target value rₜ^{fixed} in which the control command value u and the state quantity x do not deviate from the running condition 121. When a lower limit or an upper limit is not set, a restriction can be invalidated by using −∞/∞.

As described above, the operation support device 100 includes the determination unit 114 that determines whether the control command value uₖ deviates from the running condition 121 of the control target 820.

The operation support device 100 includes the correction unit 115 that calculates the corrected target value rₜ^{fixed} obtained by correcting the target value rₜ to satisfy the running condition 121 when the determination unit 114 determines that the deviation occurs.

### Control Unit: Correction Unit (Correction of Control Command Value)

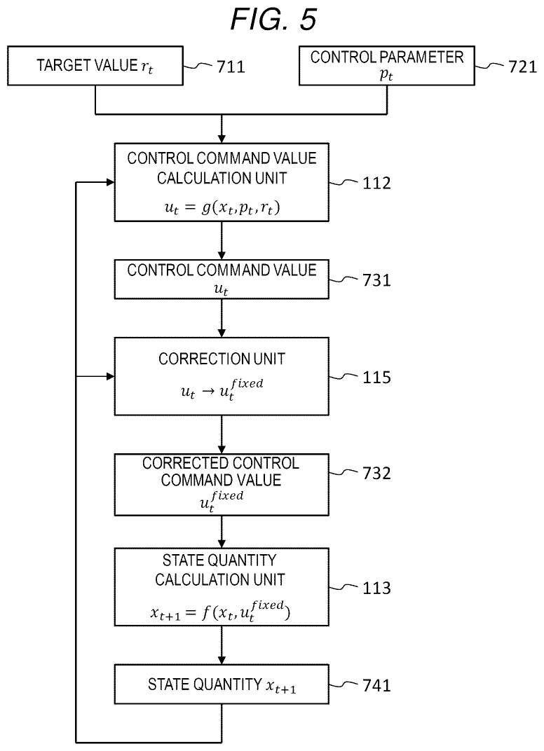

When the state quantity x deviates, the correction unit 115 may correct the control command value uₜ instead of the target value rₜ. When the state quantity x does not deviate, the correction unit 115 does not correct the control command value uₜ. FIG. 5 is a diagram showing processing in which the correction unit 115 corrects the control command value uₜ according to the first embodiment. When the control command value uₜ does not deviate from the running condition 121 and the state quantity xₜ₊₁ deviates from the running condition 121, the correction unit 115 corrects the control command value uₜ to obtain a corrected control command value uₜ^{fixed}. The correction unit 115 calculates the corrected control command value uₜ^{fixed} (t=k, . . . k+N) such that the control command value uₜ and the state quantity xₜ₊₁ (t=k, . . . k+N) do not deviate. The correction unit 115 calculates the corrected control command value uₜ^{fixed} using the following formulas (14) to (18).

$${u}^{fixed} = {arg min}_{{u}^{fixed}} {J}_{2} ( {u}^{fixed} ) \qquad ( 14 )$$

$${J}_{2} ( {u}^{fixed} ) = {\sum }_{t = k}^{k + N} {( {r}_{t} - {x}_{t} )}^{T} ( {r}_{t} - {x}_{t} ) \qquad ( 15 )$$

$${x}_{t + 1} = f ( {x}_{t} , {u}_{t}^{fixed} ) \qquad ( 16 )$$

$${u}_{m i n} \leq {u}_{t}^{fixed} \leq {u}_{m ax} \qquad ( 17 )$$

$${x}_{m i n} \leq {x}_{t} \leq {x}_{m ax} \qquad ( 18 )$$

The correction unit 115 calculates the corrected control command value uₜ^{fixed} by solving an optimization problem with constraint conditions shown in the formulas (14) to (18). The formula (14) calculates the corrected control command value uₜ^{fixed} by minimizing an objective function J₂ (u^{fixed}) in the formula (15) using the formulas (16) to (18) as constraint conditions. The formula (15) is an objective function for evaluating the sum of deviations between the target value rₜ and the state quantity xₜ. In other words, the correction unit 115 calculates the corrected control command value u^{t}_{fixed} in which the deviation between the target value rₜ and the state quantity xₜ is as small as possible and that satisfies the running condition 121 related to the control command value u and the state quantity x. This matches the concept of a general control algorithm.

The formula (16) corresponds to the dynamic feature (see the formula (2)) of the control target 820. The formula (17) is the running condition 121 related to the control command value u, and the formula (18) is the running condition 121 related to the state quantity x. By solving the optimization problem in which the formulas (17) and (18) are incorporated as constraint conditions, it is possible to calculate the corrected control command value uₜ^{fixed} in which the control command value u and the state quantity x do not deviate from the running condition 121.

As described above, the correction of the target value rₜ and the correction of the control command value uₜ are substantially the same processing. However, in the correction of the control command value uₜ, since the control command value uₜ is an optimization variable, a formula corresponding to the formula (10) is not included in the formulas (14) to (18) indicating the correction of the control command value uₜ.

As a method of correcting the target value rₜ and the control command value uₜ, the above-described method is not necessarily used, and other methods may be used. For example, a reference governor (see Patent Document 1 below) may be used to correct a target value, and a safety filter (see Patent Document 2 below) may be used to correct a control command value.

Patent Document 1: A.Bemporad, “Reference governor for constrained nonlinear systems,” IEEE Transactions on Automatic Control, vol. 43, Issue 3, pp. 415-419, 1998.

Patent Document 2: Ames, Aaron D., et al., “Control barrier functions: Theory and applications,” 2019 18th European control conference (ECC), IEEE, 2019.

The correction of the control command value uₜ instead of the target value rₜ has been described above. The control command value uₜ may be corrected based on the corrected target value rₜ^{fixed} that is a target value after correction. Specifically, the control command value calculation unit 112 calculates the control command value uₜ (a first corrected control command value) based on the corrected target value rₜ^{fixed}. The state quantity calculation unit 113 calculates a state quantity based on the first corrected control command value. When the determination unit 114 determines that the state quantity deviates from the running condition 121, the correction unit 115 calculates the control command value uₜ^{fixed} (a second corrected control command value).

As described above, the control command value calculation unit 112 calculates a control command value as the first corrected control command value again based on the corrected target value rₜ^{fixed}.

The state quantity calculation unit 113 calculates a state quantity of the control target 820 based on the first corrected control command value.

The determination unit 114 determines whether the state quantity of the control target 820 deviates from the running condition 121.

When the determination unit 114 determines that the deviation occurs, the correction unit 115 calculates the second corrected control command value uₜ^{fixed} obtained by correcting the first corrected control command value to satisfy the running condition 121.

### Control Unit: Display Control Unit

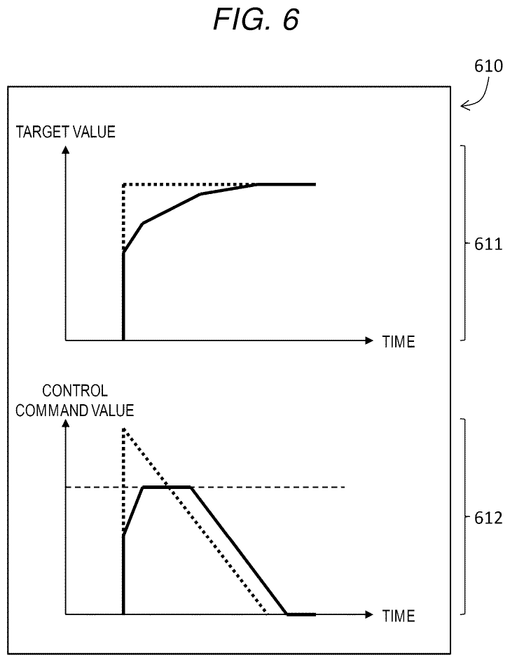

The display control unit 116 outputs a running management screen 610 (see FIG. 6 to be described later) to a display that is the user interface device 810 (see FIG. 1). FIG. 6 is a screen configuration diagram showing the running management screen 610 according to the first embodiment. A graph of the target value r is displayed in a region 611 of the running management screen 610. In this graph, a horizontal axis represents time, and a vertical axis represents a target value. A dotted line indicates a target value input or set by an operator, and a solid line indicates a corrected target value corrected by the operation support device 100 (the correction unit 115).

A graph of the control command value u is displayed in a region 612. In this graph, a horizontal axis represents time, and a vertical axis represents a control command value. A dotted line indicates a control command value based on the target value input or set by the operator, and a solid line indicates a control command value based on the corrected target value. A broken line indicates an upper limit of the control command value.

The target value input or set by the operator has a step input that rapidly rises. Therefore, a control command value calculated by the control command value calculation unit 112 based on the target value also steeply rises and exceeds the upper limit, and deviates from the running condition 121. In order to avoid such a situation, the correction unit 115 calculates the corrected target value r^{fixed} such that the target value r changes smoothly. According to the corrected target value r^{fixed}, the control command value does not deviate from the upper limit and satisfies the running condition 121 as shown in the graph of the solid line.

In this manner, the operation support device 100 displays, on the running management screen 610, what kind of situation occurs depending on a target value instructed (input or set) by an operator, and what kind of correction has been made. The operator can get a hint about what kind of operation should be performed next time and subsequent times.

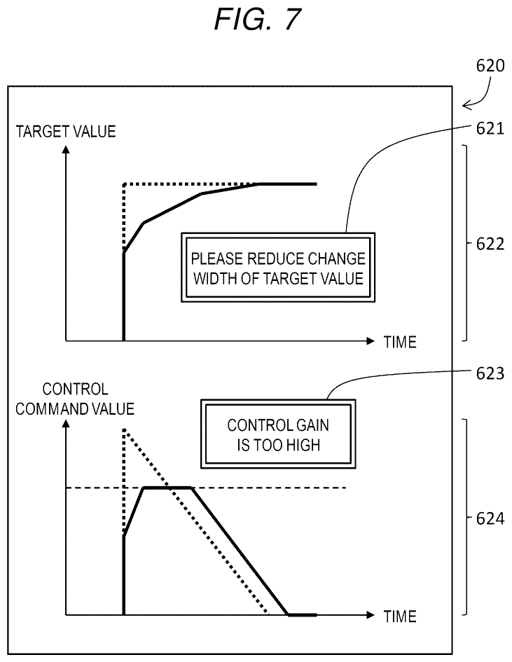

An inexperienced operator may not be able to determine what kind of improvement should be made by viewing the running management screen 610. For such an operator, the operation support device 100 may output a running management screen 620 (see FIG. 7 to be described later) on which advice is also displayed.

FIG. 7 is a screen configuration diagram showing the running management screen 620 according to the first embodiment. Graphs of a target value and a control command value displayed in the regions 622 and 624 are similar to those on the running management screen 610 (see FIG. 6). The display control unit 116 may display “Please reduce a change width of a target value” (see advice 621) so that an operator sets a target value close to a corrected target value.

The display control unit 116 may display “control gain is too high” (see advice 623) in order to eliminate a situation in which a control gain (K_{P} or K_{I}) is too high. When the control gain is lowered, a situation in which a control command deviates from an upper limit can be avoided. By displaying the advice 623 related to adjustment of the control parameter 122 in such a manner, it is possible to support not only the operator but also an engineer who adjusts a control parameter.

The running management screens 610 and 620 when the control command value u deviates from the running condition 121 have been described above. When the state quantity x of the control target 820 deviates from the running condition 121, the state quantity x may also be displayed.

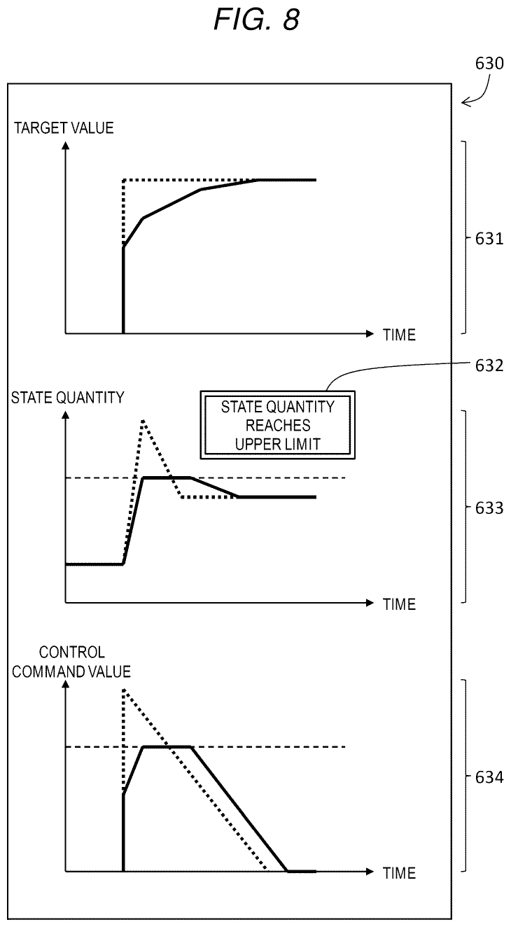

FIG. 8 is a screen configuration diagram showing a running management screen 630 according to the first embodiment. Graphs of the target value and the control command value displayed in regions 631 and 634 are similar to those on the running management screen 610 (see FIG. 6). When the state quantity x is expected to deviate from the running condition 121, the display control unit 116 may display a graph of the state quantity in a case where the target value is not corrected and a case where the target value is corrected.

In a region 633, a graph showing a predicted value of the state quantity when the target value is not corrected and an actually measured value of the state quantity after correction is displayed. In this graph, a horizontal axis represents time, and a vertical axis represents a state quantity. A dotted line indicates a predicted value of the state quantity based on a target value input or set by an operator, and a solid line indicates an actually measured value of the state quantity after the target value is corrected. A broken line indicates an upper limit of the state quantity. A warning 632 indicates that the state quantity reaches an upper limit of the running condition 121.

In this manner, the operation support device 100 displays, on the running management screen 630, what kind of situation occurs depending on a target value given by an operator and what kind of situation occurs after correction. The operator can get a hint about what kind of operation should be performed next time and subsequent times.

Since the running management screens 610 and 620 do not include an actual state quantity of the control target 820, all graphs can be displayed when an operator performs input or setting and the operation support device 100 completes processing. On the other hand, since the running management screen 630 includes an actually measured value of the state quantity x, only a waveform up to a current time can be drawn. The running management screen 630 shown in FIG. 8 is an example of a screen displayed after an actual movement.

When a control command value or a state quantity does not deviate from the running condition 121, the correction unit 115 does not correct the target value or the control command value, and thus a corrected target value and a control command value corresponding to the corrected target value are not displayed.

As described above, the operation support device 100 includes the display control unit 116 that outputs the running management screen 610 including a target value and a corrected target value.

The running management screen 620 displays contents of an operation of changing the target value to the corrected target value (see the advice 621).

### Operation Support Processing

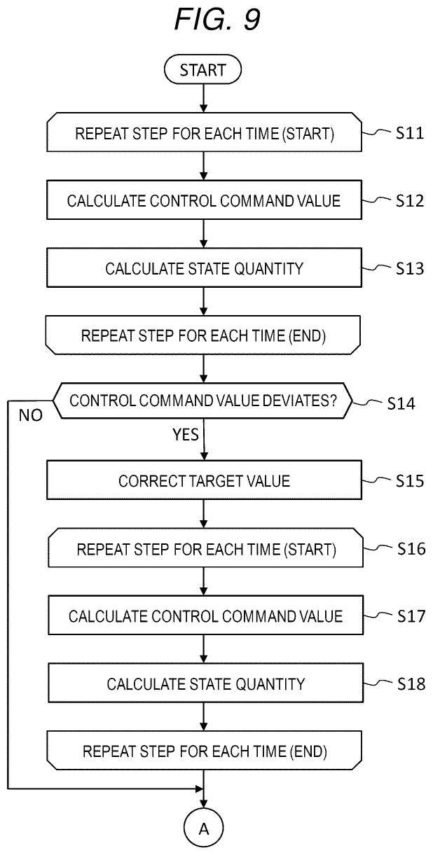

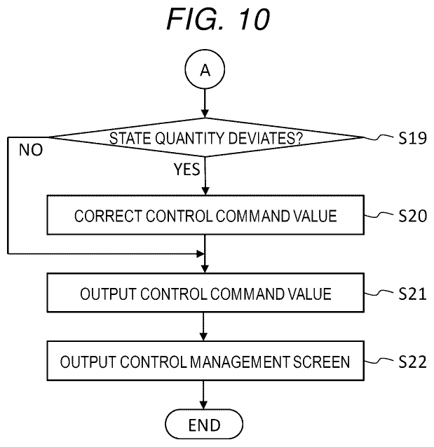

FIGS. 9 and 10 are flowcharts showing operation support processing according to the first embodiment. The operation support processing is repeated for each control cycle.

Processing of the operation support device 100 after an operator inputs or sets the target values rₖ, . . . r_{k+N} from the time k to the time k+N will be described with reference to FIGS. 9 and 10.

In step S11, the determination unit 114 starts processing of repeating steps S12 and S13 in order from a time t of k to a time t of k+N.

In step S12, the control command value calculation unit 112 calculates the control command value uₜ based on the state quantity xₜ, the target value rₜ, and the control parameter pt (see the formula (7)).

In step S13, the state quantity calculation unit 113 calculates the state quantity xₜ₊₁ at a subsequent time t+1 based on the state quantity xₜ and the control command value uₜ (see the formula (2)).

In step S14, when the control command values uₖ, . . . u_{k+N} satisfy the running condition 121 and do not deviate (NO in step S14), the determination unit 114 proceeds the processing to step S19 (see FIG. 10). When the control command values uₖ, . . . u_{k+N} do not satisfy the running condition 121 and deviate (YES in step S14), the determination unit 114 proceeds the processing to step S15.

In step S15, the correction unit 115 calculates the corrected target values rₖ^{fixed}, r_{k+N}^{fixed} (see the formulas (8) to (13)).

Steps S16 to S18 are the same as steps S11 to S13.

Referring to FIG. 10, the description of the operation support processing will be continued.

In step S19, when the state quantities xₖ₊₁, . . . x_{k+N+1} satisfy the running condition 121 and do not deviate (NO in step S19), the determination unit 114 proceeds the processing to step S21. When the control command values xₖ₊₁, . . . x_{k+N+1} do not satisfy the running condition 121 and deviate (YES in step S19), the determination unit 114 proceeds the processing to step S20.

In step S20, the correction unit 115 calculates the corrected control command values uₖ^{fixed}, . . . u_{k+N}^{fixed} (see the formulas (14) to (18)).

In step S21, the control command value calculation unit 112 outputs a control command value to the control target 820. When the corrected control command value uₖ^{fixed} is calculated in step S20, the control command value calculation unit 112 outputs the corrected control command value uₖ^{fixed}. When the control command value uₖ is calculated in step S17, the control command value calculation unit 112 outputs the control command value uₖ. When steps S17 and S20 are skipped, the control command value calculation unit 112 outputs the control command value uₖ calculated in step S12.

In step S22, the display control unit 116 outputs the running management screens 610, 620, and 630.

### Feature of Operation Support Device

Based on a target value input or set by an operator, the operation support device 100 determines whether a control command value or a state quantity up to a predetermined time (t=k, . . . k+N) deviates from the running condition 121. When the deviation occurs, the operation support device 100 corrects the target value or the control command value (see step S15 in FIG. 9 and step S20 in FIG. 10).

According to such an operation support device 100, even if the operator performs an erroneous operation, it is possible to guarantee that the state quantity or the control command value of the control target 820 does not deviate from the running condition 121. That is, the control target 820 can be safely run within a range in which an accident or a dangerous state does not occur. Therefore, the operator can perform various operations by trial and error in accordance with intention of the operator. By repeating such trial and error, the operator can understand features of the operation support device 100 and features of a running operation on the control target 820. As a result, the operator can acquire the ability for making a determination by performing trial and error for an operation based on own determination, and can be expected to improve the skill level.

When the operator performs an inappropriate operation, the intervention by the operation support device 100 is displayed on the running management screens 610, 620, and 630. Therefore, the operator can efficiently learn an operation that should not be performed.

Further, while the operator repeats various operations by trial and error, there is a possibility that an appropriate running method that a skilled operator did not notice in the past can be found. It is also an advantage of the present invention that such a search for optimum running cannot be realized by an operator who follows a guidance function for reproducing an operation of a skilled operator as in Patent Literature 1.

An existing control system has a configuration in which a recommended operation is provided to an operator as guidance, and the operator operates the control system according to the provided guidance. Such a system can be constructed only in a control system in which know-how of a skilled operator can be used. On the other hand, the operation support device 100 can be applied by setting the running condition 121 even in a case where an ideal state or operation is unknown in the new control target 820.

### Modification: Prediction Period

In the above-described embodiment, the deviation is determined by calculating a control command value or a state quantity in a time up to N steps ahead. Since the deviation determination can be performed at an earlier timing as a prediction time for the deviation determination is longer, the correction unit 115 can perform smooth correction. On the other hand, a large number of calculations are required to perform long-term prediction. In order to avoid the deviation from the running condition 121, one step of a control cycle is sufficient as the prediction period.

### Modification: Control Command Value Calculation Unit

The control command value calculation unit 112 calculates the control command value u with reference to the target value r and the control parameter p. Any control algorithm may be implemented in the control command value calculation unit 112. For example, the control algorithm may be proportional integral control as described above, or may be predictive control (MPC). Since MPC is a control algorithm capable of handling a constraint condition, it is possible to calculate a control command value that does not deviate from the running condition 121 regardless of the target value r. Therefore, the correction unit 115 that corrects the target value is not essential. When MPC is used, the control command value u can be calculated using formulas (19) to (23). Here, Q and R in the formula (20) are weight parameters and are treated as the control parameter 122.

$$u = {arg min}_{u} {J}_{3} ( u ) \qquad ( 19 )$$

$${J}_{3} ( u ) = {\sum }_{t = k}^{k + N} \{ {( {r}_{t} - {x}_{t} )}^{T} Q ( {r}_{t} - {x}_{t} ) + {u}_{t}^{T} R {u}_{t} \} \qquad ( 20 )$$

$${x}_{t + 1} = f ( {x}_{t} , {u}_{t} ) \qquad ( 21 )$$

$${u}_{m i n} \leq {u}_{t} \leq {u}_{m ax} \qquad ( 22 )$$

$${x}_{m i n} \leq {x}_{t} \leq {x}_{m ax} \qquad ( 23 )$$

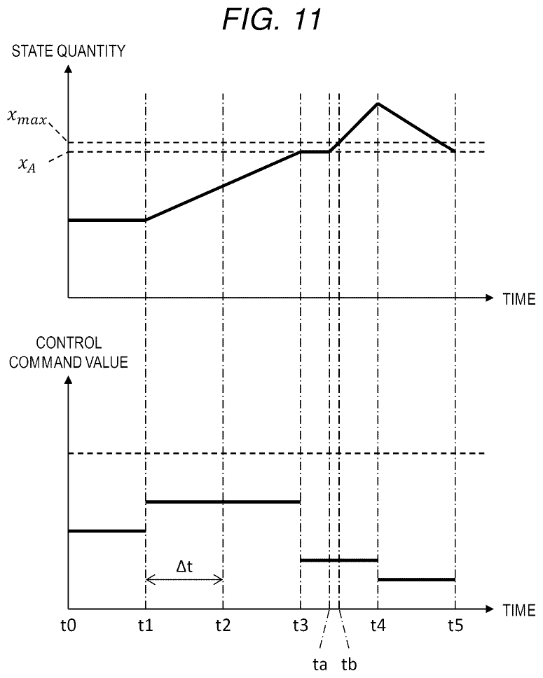

Since a calculation load of MPC is high, a calculation cycle (control cycle) of the control command value is often lengthened. In such a case, as shown in FIG. 11 to be described later, there is a possibility that deviation from the running condition 121 occurs between control cycles. FIG. 11 is a diagram showing the deviation of the state quantity when the control cycle is long according to the first embodiment. An upper side of FIG. 11 shows a graph of a state quantity, and a lower side shows a graph of a control command value. A control cycle that is a cycle for calculating the control command value is Δt.

It is assumed that a control command that causes the state quantity to stay at x_{A} is given at a time t3. If no particular change occurs in this situation, the state quantity is maintained at x_{A} until a time t4. However, actually, the state quantity may exceed an upper limit xₘₐₓ due to the influence of disturbance at a time ta. Since a control command value is maintained at a control command value at the time t3 during the control cycle Δt, the state quantity exceeds the upper limit xₘₐₓ at a time tb.

The correction unit 115 can solve such a situation. A calculation cycle of the correction unit 115 is set to a cycle δt shorter than the control cycle Δt, and the correction unit 115 corrects the control command value u in the cycle δt. For example, δt=tb−ta.

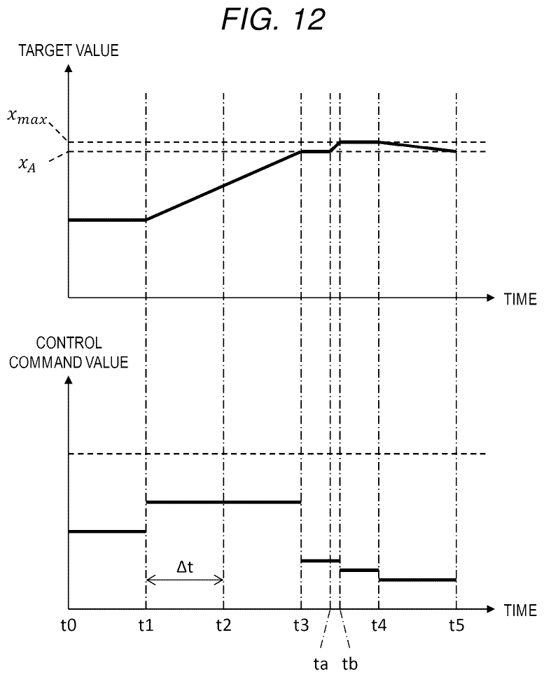

FIG. 12 is a diagram showing prevention of deviation of a state quantity when a control command value is corrected in the short cycle δt according to the first embodiment. It is possible to prevent the state quantity from deviating from and exceeding the upper limit xₘₐₓ by the correction unit 115 correcting the control command value at the time tb. Since a safety filter (see Patent Document 2) has a lower calculation load than the MPC, the cycle δt can be significantly shortened as compared with the control cycle Δt of the MPC.

### Modification: Running Management Screen

A state quantity displayed in the region 633 of the running management screen 630 (see FIG. 8) is an actually measured value of the state quantity of the control target 820. Instead of the actually measured value, a predicted value of a state quantity calculated by the state quantity calculation unit 113 may be displayed. By referring to the predicted value, an operator can know how a future state quantity changes depending on a current target value, and can accumulate operation know-how.

### Second Embodiment

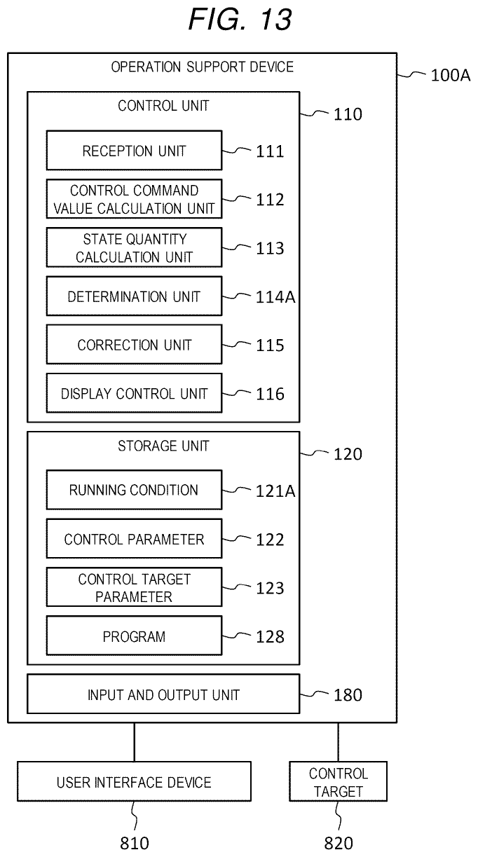

In the first embodiment, the running condition 121 including an upper limit and a lower limit of a control command value or a state quantity is fixed. However, depending on the control target 820, the upper limit and the lower limit of another state quantity may change according to a certain state quantity. For example, in a plant that controls a thermal fluid, a limit of an allowable flow rate may be changed according to a temperature of the fluid. An operation support device 100A (see FIG. 13 to be described later) according to the second embodiment corresponds to a case where the running condition 121 changes according to the state quantity x in such a manner.

FIG. 13 is a functional block diagram showing the operation support device 100A according to the second embodiment. A determination unit 114A and a running condition 121A are different from those of the operation support device 100 (see FIG. 1) according to the first embodiment. The running condition 121A does not indicate a fixed upper limit or lower limit of a control command value or a state quantity, but indicates an upper limit or lower limit of a certain state quantity. For example, the running condition 121A includes a table indicating an upper limit of a flow rate for each temperature of the fluid. Such a table can be regarded as formulas (24) and (25).

$${u}_{m i n} ( {x}_{k} ) \leq {u}_{t} \leq {u}_{m ax} ( {x}_{k} ) \qquad ( 24 )$$

$${x}_{m i n} ( {x}_{k} ) \leq {x}_{t} \leq {x}_{m ax} ( {x}_{k} ) \qquad ( 25 )$$

The determination unit 114A determines whether the running condition 121A is satisfied by determining whether the control command value uₜ and the state quantity xₜ₊₁ (t=k+1, . . . k+N) calculated using the formula (2) and the formula (7) satisfy the formulas (24) and (25).

As described above, the running condition 121A includes a condition for a second state quantity that changes according to a first state quantity (see the formula (25) or a condition for a control command value that changes according to the first state quantity (see the formula (24).

### Third Embodiment

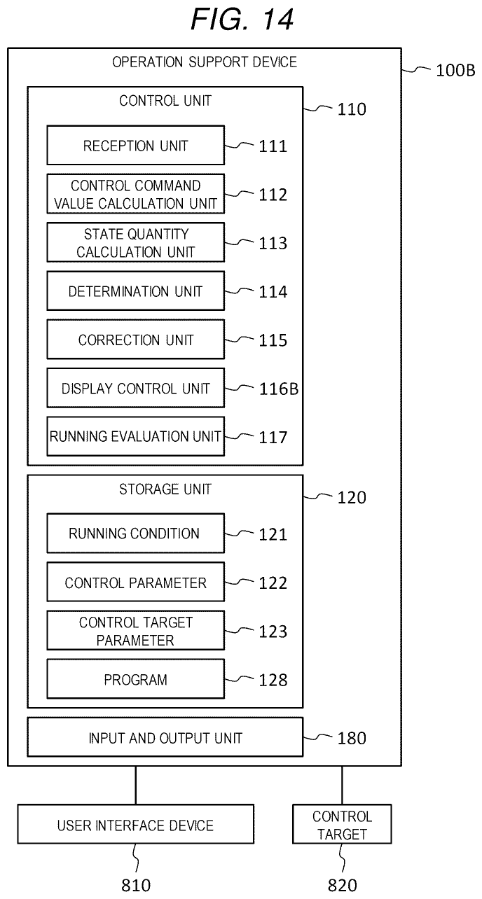

As described above, according to the operation support device 100, it is possible to safely run the control target 820 while allowing trial and error for an operation by an operator. On the other hand, when the degree of freedom of the operation is too high, it is expected that the operator has difficulty in determining what to try. An operation support device 100B (see FIG. 14 to be described later) according to the third embodiment supports determination of an operator by notifying the operator of a running situation of the control target 820.

FIG. 14 is a functional block diagram showing the operation support device 100B according to the third embodiment. As compared with the operation support device 100 (see FIG. 1) according to the first embodiment, the control unit 110 includes a running evaluation unit 117, and a display control unit 116B which is different. The running evaluation unit 117 calculates a key performance indicator related to an operation of the control target 820 based on a corrected target value, a control command value, a corrected control command value, and an actually measured value of a state quantity of the control target 820.

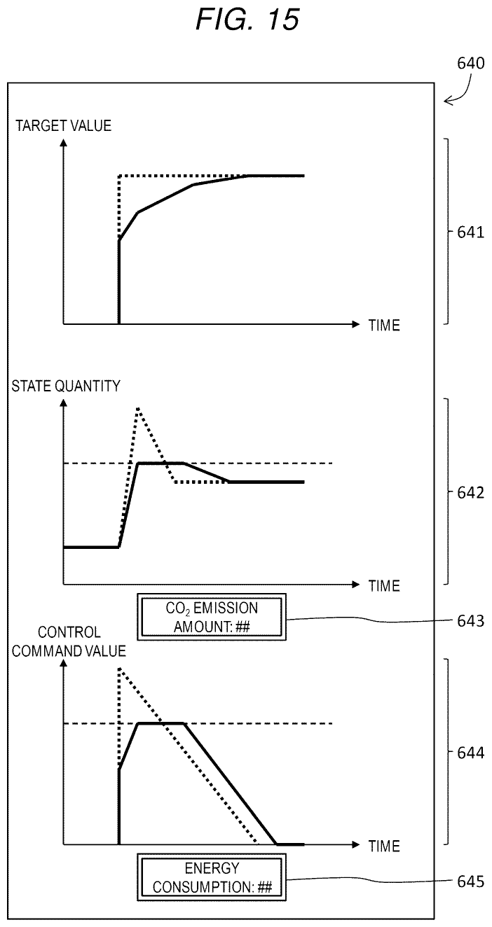

Examples of the key performance indicator (KPI) include energy consumption and CO2 emission. The display control unit 116B outputs a running management screen 640 (see FIG. 15 to be described later).

FIG. 15 is a screen configuration diagram showing the running management screen 640 according to the third embodiment. Graphs of a target value, a state quantity, and a control command value displayed in regions 641, 642, and 644 are similar to those on the running management screen 630 (see FIG. 8). The display control unit 116B displays KPIs 643 and 645 calculated by the running evaluation unit 117 in addition to the target value, the state quantity, and the control command value.

By referring to the KPIs 643 and 645, an operator can consider what kind of operation should be performed in order to increase or decrease the KPI. By providing such additional information, the operator can be expected to be able to understand features of the control target 820 more deeply.

As described above, the operation support device 100B includes the running evaluation unit 117 that calculates an evaluation indicator (KPI) based on at least one of the control command value, the second corrected control command value, and the state quantity.

The running management screen 640 includes the evaluation indicator (see the KPIs 643 and 645).

### Fourth Embodiment

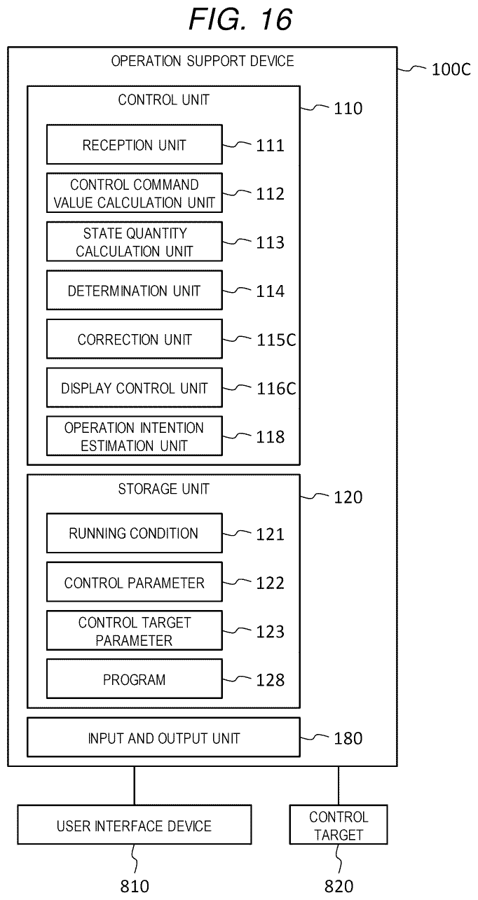

As described above, according to the operation support device 100, it is possible to safely run the control target 820 while allowing trial and error for an operation by an operator. On the other hand, depending on the control target 820, the throughput may greatly change even if a running state changes slightly. In the case of such a control target, it is important to reduce the number of trials and errors by the operator as much as possible and quickly bring a running state close to a desirable running state. An operation support device 100C (see FIG. 16 to be described later) according to the fourth embodiment supports running of the control target 820 in such a manner.

FIG. 16 is a functional block diagram showing the operation support device 100C according to the fourth embodiment. As compared with the operation support device 100 (see FIG. 1) according to the first embodiment, the control unit 110 includes an operation intention estimation unit 118, and a correction unit 115C and a display control unit 116C, which are different. The operation intention estimation unit 118 estimates an operation intention of an operator based on input or setting contents of the operator and history of the input or setting contents. For example, preference learning as shown in Patent Document 3 can be used to estimate an operation intention of an operator. The operation intention includes improvement of a KPI (for example, energy consumption).

Patent Document 3: W. Chu, and Z. Ghahramani, “Preference learning with Gaussian processes,” Proceedings of the 22nd international conference on Machine learning, pp. 137-144, 2005.

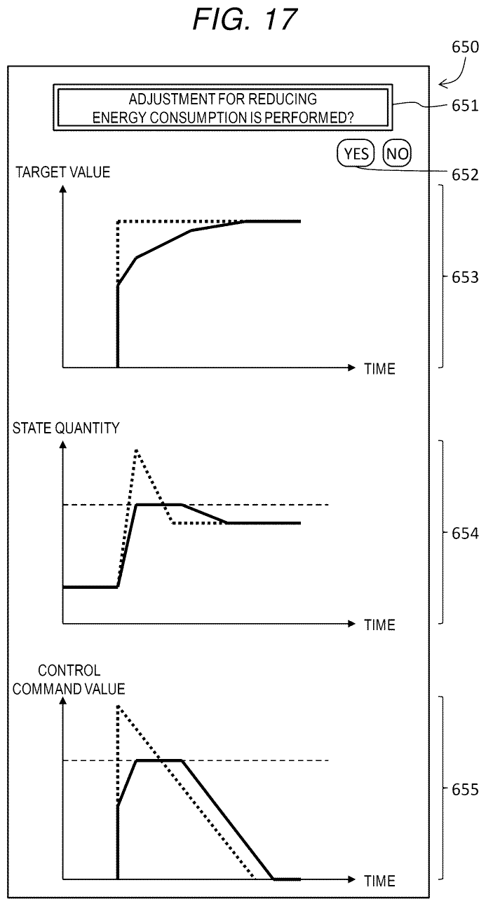

The display control unit 116C outputs a running management screen 650 (see FIG. 17 to be described later). FIG. 17 is a screen configuration diagram showing the running management screen 650 according to the fourth embodiment. Graphs of a target value, a state quantity, and a control command value displayed in regions 653, 654, and 655 are similar to those on the running management screen 630 (see FIG. 8). The display control unit 116C displays a confirmation message 651 based on an operation intention of an operator, which is calculated by the operation intention estimation unit 118, in addition to the target value, the state quantity, and the control command value. When the operation intention calculated by the operation intention estimation unit 118 matches an intention of the operator, the operator presses a “YES” button 652. Then, the correction unit 115C calculates the corrected target value r^{fixed} by solving an optimization problem with constraint conditions shown in formulas (26) to (31).

$${r}^{fixed} = {arg min}_{{r}^{fixed}} {J}_{4} ( {r}^{fixed} ) \qquad ( 26 )$$

$${J}_{4} ( {r}^{fixed} ) = {\sum }_{t = k}^{k + N} \{ {( {r}_{t}^{fixed} - {x}_{t} )}^{T} Q ( {r}_{t}^{fixed} - {x}_{t} ) + {u}_{t}^{T} R {u}_{t} \} \qquad ( 27 )$$

$${u}_{t} = g ( {x}_{t} , {p}_{t} , {r}_{t}^{fixed} ) \qquad ( 28 )$$

$${x}_{t + 1} = f ( {x}_{t} , {u}_{t} ) \qquad ( 29 )$$

$${u}_{m i n} \leq {u}_{t} \leq {u}_{m ax} \qquad ( 30 )$$

$${x}_{m i n} \leq {x}_{t} \leq {x}_{m ax} \qquad ( 31 )$$

An objective function of the formula (27) is a function including any one of a state quantity, a control command value, and a target value, the form of which changes according to an estimated operation intention. The objective function is, for example, an objective function for evaluating a cumulative value of energy consumption when energy consumption is desired to be reduced, and an objective function for evaluating a cumulative value of CO2 emission when CO2 emission is desired to be reduced. In other words, the correction unit 115C calculates a corrected target value that maximizes or minimizes an intended evaluation indicator (for example, energy consumption).

As described above, the operation support device 100C includes the operation intention estimation unit 118 that estimates an intention of an instructed operation.

The correction unit 115C corrects a target value to maximize or minimize an intended evaluation indicator calculated based on at least one of a control command value and a state quantity.

### Fifth Embodiment

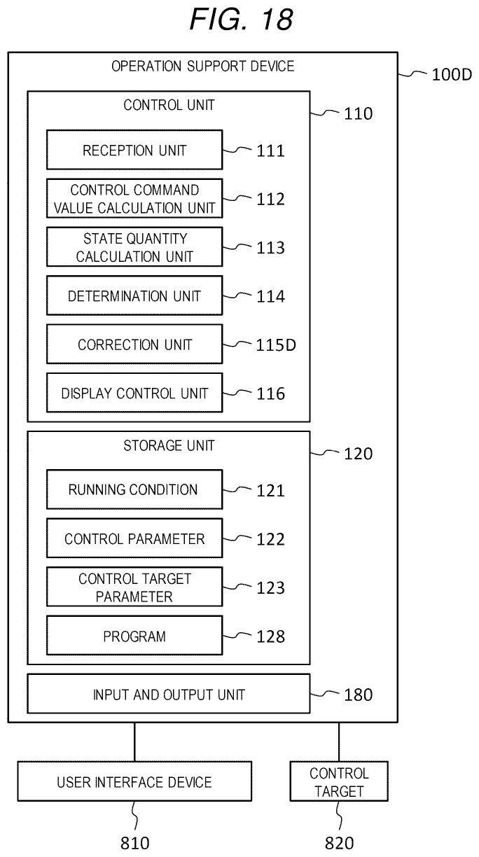

The operation support device 100 according to the first embodiment provides the advice 623 (see FIG. 7) such as “control gain is too high”. An experienced operator can determine how much the control gain (the control parameter 122) should be reduced, but a beginner operator may not be able to determine what control gain setting is appropriate. Therefore, it is desirable to provide a function of supporting appropriate control gain setting. An operation support device 100D (see FIG. 18 to be described later) according to a fifth embodiment supports the setting of the control parameter 122 in such a manner.

FIG. 18 is a functional block diagram showing the operation support device 100D according to the fifth embodiment. The correction unit 115D of the control unit 110 is different from that of the operation support device 100 (see FIG. 1) according to the first embodiment. The correction unit 115D calculates the corrected target value r^{fixed} as in the first embodiment, and corrects the control parameter 122 such that the state quantity x of the control target 820 approaches the corrected target value r^{fixed}.

The correction unit 115D corrects the control parameter 122 by a method such as Bayesian optimization. In order to execute Bayesian optimization, it is necessary to select a parameter candidate and evaluate the parameter candidate. The control command value calculation unit 112 calculates the control command value u with reference to the parameter candidate selected by the correction unit 115D. The state quantity calculation unit 113 calculates the state quantity x when the control command value u is used. The correction unit 115D evaluates a difference between the state quantity x and the corrected target value r^{fixed}, and can determine that running can be performed in which the state quantity becomes the corrected target value r^{fixed} by using the parameter candidate when the difference is sufficiently small. An operator can understand what kind of control gain setting should be made by displaying a corrected value of the control parameter 122 on a running management screen.

As described above, the control command value calculation unit 112 refers to the control parameter 122 (see the control gains K_{P} and K_{I}) when calculating a control command value.

The correction unit 115D corrects the control parameter 122 to reduce a difference between the corrected target value r^{fixed} and the state quantity x of the control target 820.

### Other Modifications

While certain embodiments have been described, these embodiments have been presented by way of example only, and are not intended to limit the technical scope of the inventions. In the embodiments described above, the control target 820 is assumed to be a plant, but is not limited thereto. The control target 820 may be an automobile, a construction machine, or the like, and can also be used to support an operator (driver). In the embodiments described above, the operation support device 100, 100A, 100B, 100C, 100D outputs a control command value or a corrected control command value to the control target 820. Alternatively, the operation support device 100, 100A, 100B, 100C, 100D does not output a control command value or a corrected control command value to the actual control target 820, and may be used as a simulation device for training an operator.

The determination unit 114, 114A determines whether a control command value or a state quantity does not deviate from the running condition 121, 121A using a control command value calculated by the control command value calculation unit 112 or a state quantity calculated by the state quantity calculation unit 113. The determination unit 114, 114A may determine the deviation by calculating the control command value or the state quantity by executing the processing of the control command value calculation unit 112 or the state quantity calculation unit 113 by the determination unit 114, 114A.

The correction unit 115, 115C, 115D calculates a corrected target value or a corrected control command value using a control command value calculated by the control command value calculation unit 112 or a state quantity calculated by the state quantity calculation unit 113 (see the formulas (10) and (11)). The correction unit 115, 115C, 115D may perform correction by calculating the control command value or the state quantity by executing the processing of the control command value calculation unit 112 and the state quantity calculation unit 113 by the correction unit 115, 115C, 115D.

The present invention may be embodied in a variety of other embodiments, and further various omissions, substitutions and changes may be made without departing from the spirit of the invention. The accompanying claims and their equivalents described in the present specification are intended to cover such embodiments or modifications as would fall within the scope and spirit of the invention.

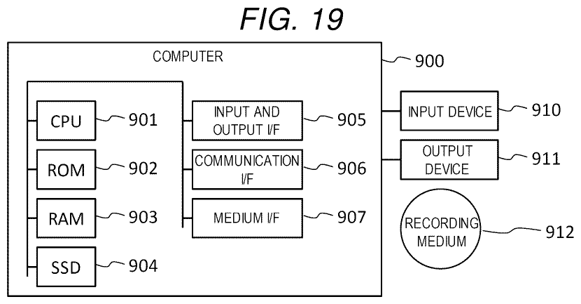

Hardware Configuration The operation support device 100, 100A, 100B, 100C, 100D according to the embodiments described above is implemented by, for example, a computer 900 having a configuration as shown in FIG. 19. FIG. 19 is a hardware configuration diagram showing an example of the computer 900 that implements functions of the operation support device 100, 100A, 100B, 100C, 100D according to the embodiments described above. The computer 900 includes a CPU 901, a ROM 902, a RAM 903, an SSD 904, and an input and output interface 905 (described as an input and output interface (I/F) in FIG. 19). The computer 900 further includes a communication interface 906 (described as a communication I/F in FIG. 19) and a medium interface 907 (described as a medium I/F in FIG. 19). The computer 900 may include a hard disc drive (HDD) instead of the SSD 904, or may further include an HDD in addition to the SSD 904.

The CPU 901 operates based on a program stored in the ROM 902 or the SSD 904, and performs control by the control unit 110 in FIG. 1. The ROM 902 stores a boot program executed by the CPU 901 when the computer 900 is activated, a program related to hardware of the computer 900, and the like.

The CPU 901 controls an input device 910 such as a mouse or a keyboard and an output device 911 such as a display or a printer via the input and output interface 905. The CPU 901 acquires data from the input device 910 via the input and output interface 905 and outputs generated data to the output device 911 via the input and output interface 905.

The SSD 904 stores a program executed by the CPU 901, data used by the program, and the like. The communication interface 906 receives data from another device (not shown) (for example, the control target 820) via a communication network and outputs the data to the CPU 901, and transmits data generated by the CPU 901 to another device via a communication network.

The medium interface 907 reads a program or data stored in a recording medium 912 and outputs the program or data to the CPU 901 via the RAM 903. The CPU 901 loads a program from the recording medium 912 to the RAM 903 via the medium interface 907 and executes the loaded program. The recording medium 912 is an optical recording medium such as a digital versatile disk (DVD), a magneto optical recording medium such as a magneto optical disk (MO), a magnetic recording medium, a semiconductor memory tape medium, a semiconductor memory, or the like.

For example, when the computer 900 functions as the operation support device 100, 100A, 100B, 100C, 100D according to the embodiments described above, the CPU 901 of the computer 900 implements functions of the operation support device 100, 100A, 100B, 100C, 100D by executing the program 128 (see FIG. 1) loaded on the RAM 903. The CPU 901 reads the program from the recording medium 912 and executes the program. In addition, the CPU 901 may read a program from another device via a communication network, or may install the program 128 in the SSD 904 from the recording medium 912 and execute the program.

What is claimed is:

1. An operation support device comprising:
a control command value calculation unit configured to calculate a control command value for a control target based on a target value of a state quantity to be operated on the control target;
a determination unit configured to determine whether the control command value deviates from a running condition of the control target;
a correction unit configured to calculate a corrected target value obtained by correcting the target value to satisfy the running condition when the determination unit determines that the control command value deviates from the running condition; and
a display control unit configured to output a running management screen including the target value and the corrected target value.

2. An operation support device comprising:
a control command value calculation unit configured to calculate a control command value for a control target based on a target value of a state quantity to be operated on the control target;
a state quantity calculation unit configured to calculate a state quantity of the control target based on the control command value;
a determination unit configured to determine whether the control command value deviates from a running condition of the control target; and
a correction unit configured to calculate a corrected target value obtained by correcting the target value to satisfy the running condition when the determination unit determines that the control command value deviates from the running condition, wherein
the control command value calculation unit calculates the control command value as a first corrected control command value based on the corrected target value,
the state quantity calculation unit calculates the state quantity of the control target based on the first corrected control command value,
the determination unit determines whether the state quantity of the control target deviates from the running condition, and
the correction unit calculates a second corrected control command value obtained by correcting the first corrected control command value to satisfy the running condition when the determination unit determines that the state quantity of the control target deviates from the running condition.

3. The operation support device according to claim 2, further comprising:
a display control unit configured to output a running management screen including the target value and the corrected target value.

4. The operation support device according to claim 3, wherein
the running management screen further displays operation content of changing the target value to the corrected target value.

5. The operation support device according to claim 3, further comprising:
a running evaluation unit configured to calculate an evaluation indicator based on at least one of the control command value, the second corrected control command value, and the state quantity, wherein
the running management screen includes the evaluation indicator.

6. The operation support device according to claim 2, wherein
the control command value calculation unit refers to a control parameter when calculating the control command value, and
the correction unit corrects the control parameter to reduce a difference between the corrected target value and the state quantity of the control target.

7. The operation support device according to claim 2, wherein
the running condition includes
a condition for a second state quantity that changes according to a first state quantity, or
a condition for the control command value that changes according to the first state quantity.

8. The operation support device according to claim 2, further comprising:
an operation intention estimation unit configured to estimate an intention of an instructed operation, wherein
the correction unit corrects the target value to maximize or minimize an evaluation indicator calculated based on at least one of a control command value and a state quantity which serve as the intention.

9. A running management system comprising:
a control target; and
the operation support device according to claim 1.

10. A running management system comprising:
a control target; and
the operation support device according to claim 2.

11. An operation support method comprising:
executed by an operation support device,
calculating a control command value for a control target based on a target value of a state quantity to be operated on the control target;
determining whether the control command value deviates from a running condition of the control target;
calculating a corrected target value obtained by correcting the target value to satisfy the running condition when it is determined that the control command value deviates from the running condition of the control target; and
outputting a running management screen including the target value and the corrected target value.
